(19) United States
(12) Patent Application Publication
(10) Pub. No.: US 2003/0139276 A1
(43) Pub. Date: Jul. 24, 2003

(54) Method of making a pinata

(76) Inventor: Hector Lozano, Los Angeles, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 10/051,534

(22) Filed: Jan. 18, 2002

(51) Int. Cl. B31B 1/00

(52) U.S. Cl. 493/480

(57) ABSTRACT

Decorative shapes are designed and translated into die-cut cardboard pieces which can be hand folded into full-size three-dimensional forms and secured with glue. Several pieces can be joined to form elaborate and fanciful shapes, such as animals, human figures or inanimate objects. By providing a large number of cut lines, a curved shape can be achieved. The cardboard includes a precut opening for adding candy and a suitable place for attachment of a wire or other hanger. In a short amount of time, a finished pinata can be ready for decorating. The present invention has a number of novel features which render it highly advantageous for making piñatas. The use of initially planar cardboard members that are pre-cut for creating curved surfaces, is one such feature. The use of glue to affix those members to one another is still another such features. The method of creating a pinata without requiring time consuming drying or using paper mache or a balloon, is yet another novel feature.

### BACKGROUND OF THE INVENTION

1. Field of the Invention

The present invention relates to pinatas, and to methods of making them.

2. Background Art

Pinatas have been used on festive occasions for hundreds of years. They were originally a simple clay pot which could be filled with candy and suspended by a rope. Blindfolded children were given a stick with which they could attempt to break the piñata. Once the piñata was broken, everyone scrambled for the fallen candy. The custom was brought to the Western hemisphere by early Spanish explorers, and the basic design remained the same—a plain, undecorated clay pot. With the arrival of tissue paper, Mexicans began to decorate their piñatas with fanciful colors and designs and became enchanted with their colorful pinatas and the demand increased. Manufacturers were motivated to find a faster method of making the pinatas.

More recently piñatas have been made out of paper màché, and that has remained the method of choice. Using paper màché, pinatas may be made in many shapes, often having the form of known figures such as animals and the like.

A method for making pinatas out of paper mache employs the following steps: 1) A support structure is formed, e.g. rolled or wadded newspapers, balloons, or Styrofoam blocks; 2) Strips of newspapers (e.g. approximately 2″ wide) are dipped in a pasted and layered over the support form to cover it completely; 3) “Appendages” may be added while the piñata is still wet, i.e. any part (such as a donkey's ears) which does not need to be a part of the main container; 4) The piñata must be allowed to dry completely; 5) Once dry, the pinata is cut in half to remove the support structure, and the two halves fastened together with tape; 6) A hole is made in the pinata to allow candy to be added and a rope or wire is secured to allow the pinata to be suspended properly; 7) The pinata is then decorated, typically with tissue paper cut in fringed strips.

Although paper màché piñatas have been used successfully since the middle of the twentieth century, there are several drawbacks to this method. A great deal of time and skill are needed to form the paper mache shapes in an artistic and consistent manner. Once the pinatas are formed, they need a long time to dry properly and their size and shape require a large amount of space. Also, paper mache pinatas don't break as easily as clay pots.

### SUMMARY OF THE INVENTION

Attempts have been made to find new methods of making the piñatas such as using a balloon core, but the invention here disclosed is a significant new method.

Functionally, a pinata design has several requirements: 1) It must hold a substantial volume and weight (perhaps 2-5 pounds) of candy; 2) it must be capable of being suspended when filled without spilling its contents; 3) it must break when struck firmly or have another means of releasing the enclosed candy on demand.

These requirements are satisfied in the presently preferred embodiment, by an inventive process which uses pre-cut cardboard. Decorative shapes are designed and translated into die-cut cardboard pieces which can be hand folded into full-size three-dimensional forms and secured with glue. Several pieces can be joined to form elaborate and fanciful shapes, such as animals, human figures or inanimate objects. By providing a large number of cut lines, a curved shape can be achieved. The cardboard includes a precut opening for adding candy and a suitable place for attachment of a wire or other hanger. In a short amount of time, a finished pinata can be ready for decorating.

The advantages of the glued cardboard method are numerous. There is no time-consuming layering of paper màché, nor waiting for the paper mache to dry, and no need to remove the support structure and refasten the pieces. The folding can be done with a minimum of skill, yet the finished forms are consistent (unlike traditional piñatas). If desired, the pieces can even be shipped flat, to be assembled at the destination and decorated by the consumer, thus saving on shipping costs.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a top view of an assembled illustrative embodiment of a pinata made in accordance with the inventive method;

FIG. 2 is a side view of the embodiment of FIG. 1;

FIG. 3 is a plan view of a radial part of the illustrated embodiment;

FIG. 4 is a plan view of an outer axial part of the illustrated embodiment;

FIG. 5 is a plan view of a decorative pompon;

FIG. 6 is a plan view of an inner axial part of the illustrated embodiment;

FIG. 7 is a plan view of a decorative surface feature;

FIG. 8 is a cross-sectional view of the assembled embodiment of FIG. 1; and

FIG. 9 is a plan view of the cardboard pattern of a cone of the embodiment of FIG. 1.

### DETAILED DESCRIPTION OF A PREFERRED EMBODIMENT

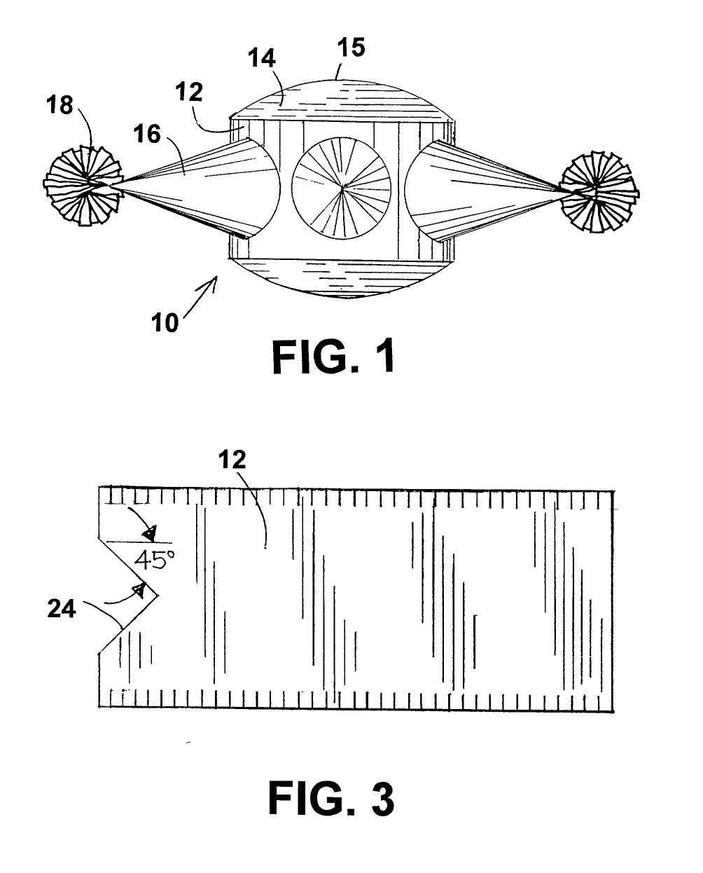

Referring to the accompanying figures and to FIGS. 1 and 2 in particular, it will be seen that a star-shaped pinata 10 comprises a radial surface 12, an axial surface perimeter 14 and an axial surface center 15. A plurality of cones 16 extend symmetrically from radial surface 12 around the periphery of pinata 10. Each such cone has connected at its apex a pompon 18. Surface decoration 20 may be applied to all of the exterior surfaces. A twine rope 22 is secured around radial surface 12 and through a selected cone 16 to provide a hanging mechanism for the pinata.

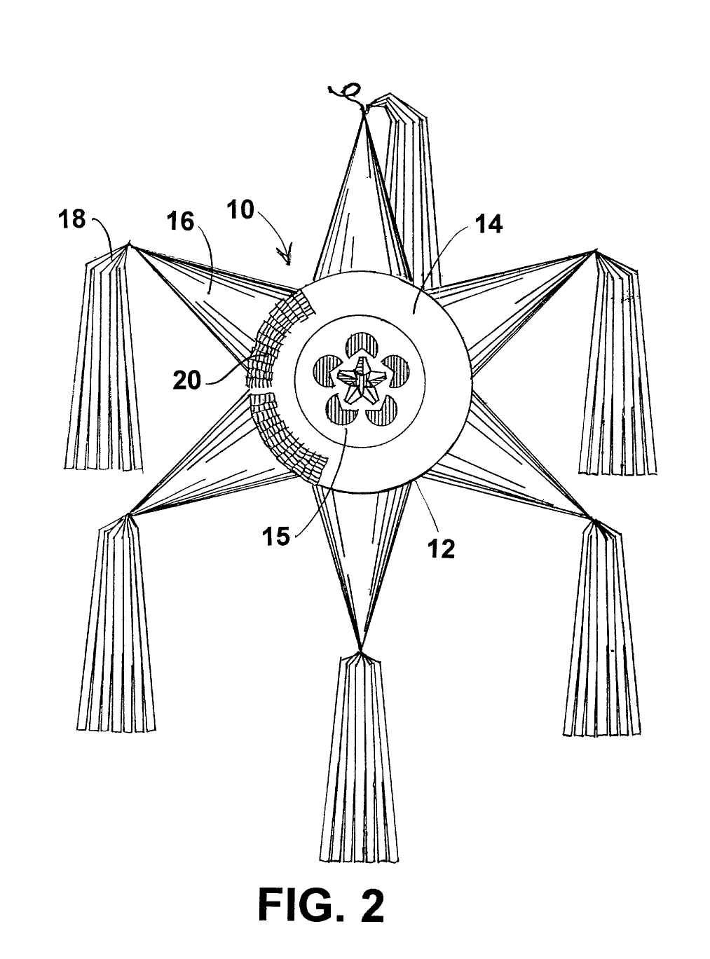

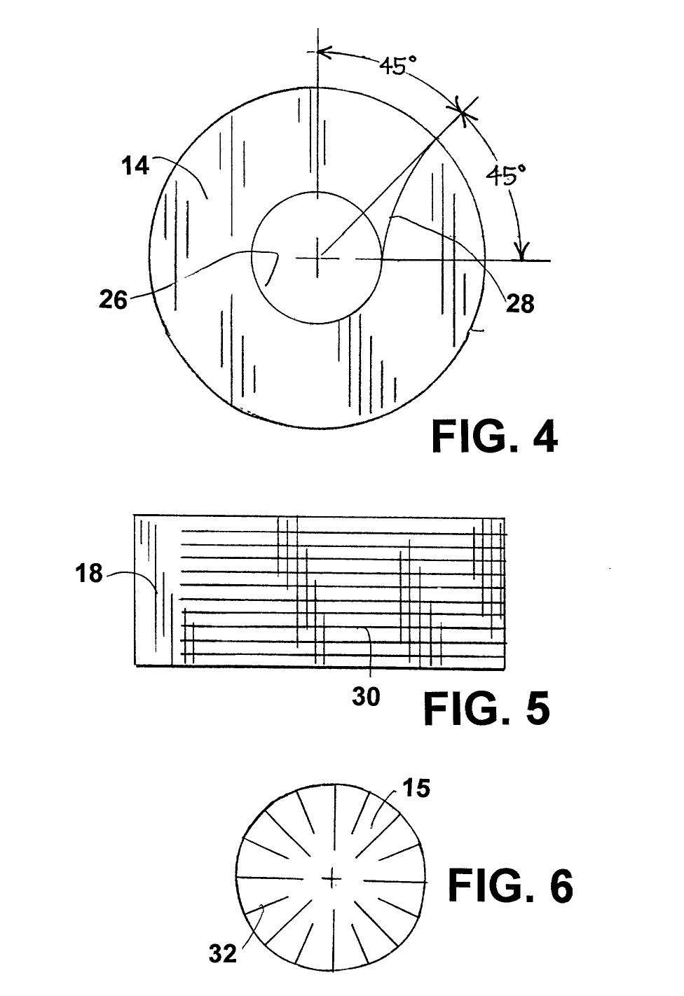

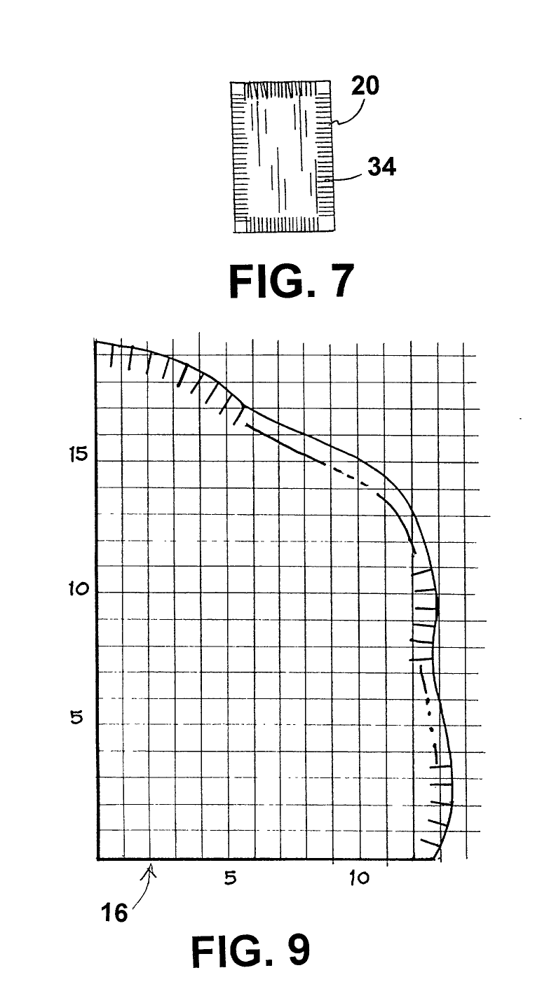

Referring to FIGS. 3 to 9, it will be seen that each of the major constituent parts of the pinata 10 is formed from a planar cardboard member. FIG. 3 illustrates the planar cardboard configuration for radial surface 12. A 45 degree cutout provides access to the interior of the pinata to load candy. FIG. 4 illustrates the axial surface perimeter 14 in its planar configuration. Surface 14 is an annulus with a circular cutout 26 at the center. An arched cut 28 permits surface 14 to form a curved or convex shape on pinata 10. FIG. 5 illustrates the planar crepe paper configuration for the pompons 18 which comprise a series of parallel linear cuts 30. FIG. 6 illustrates the planar cardboard configuration of the axial surface center 15. Surface 15 comprises a circular form having a plurality of alternating long and short radial cuts 32 spaced from the center and extending to the outer perimeter, thereby permitting surface 15 to be configured as a convex surface. FIG. 7 shows a planar crepe paper configuration for surface decorations 20 including closely spaced perimeter cuts 34. FIG. 9 illustrates the planar cardboard configuration for the cones 16. A plurality of peripheral cuts 36 facilitates forming the conical shape.

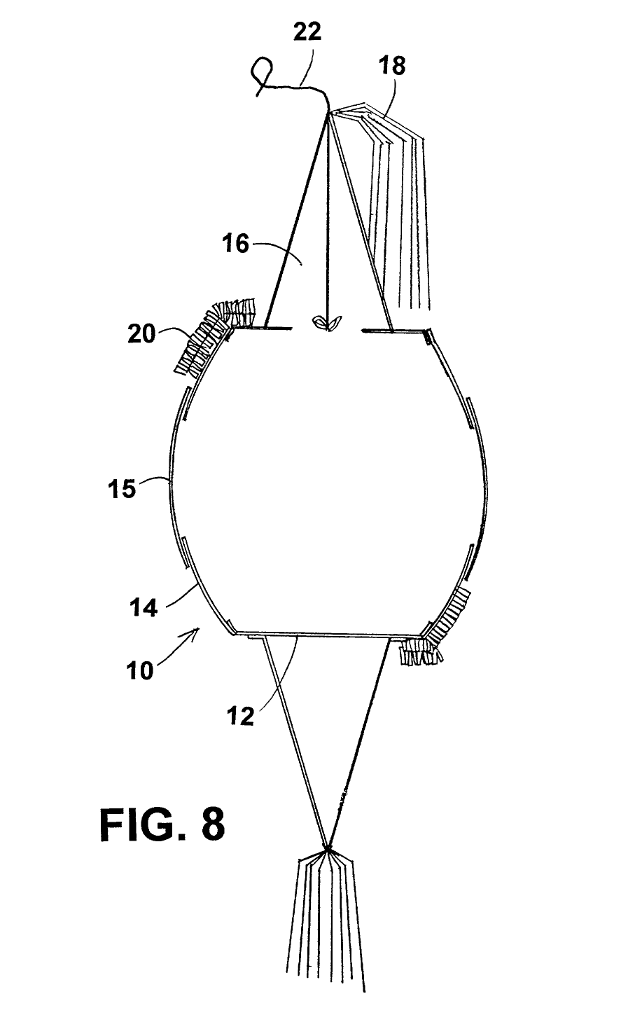

FIG. 8 shows how the various cardboard parts and surfaces are affixed together such as by gluing. Radial surface 12 is rolled into a cylindrical configuration. Axial surface perimeters 14 and axial surface centers 15 are then glued in place over the axial ends of the radial surface to form a substantially enclosed drum. After the cones 16 are formed, they are glued symmetrically to the radial surface 12. The apices are cut and the pompons 18 are then glued to the cut apices of respective cones 16. Surface decorations 20 may then be applied.

It will be seen from the disclosure made herein that the present invention has a number of novel features which render it highly advantageous for making piñatas. The use of initially planar cardboard members that are pre-cut for creating curved surfaces, is one such feature. The use of glue to affix those members to one another is still another such features. The method of creating a pinata without requiring time consuming drying or using paper màché or a balloon, is yet another novel feature. Based upon the foregoing,

What is claimed is:

1. A method of fabricating a decorative piñata; the method comprising the steps of:
a) pre-cutting separate planar cardboard members;
b) folding said members to provide individual non-planar surfaces; and
c) gluing said surfaces together to form said piñata.

2. The method recited in claim 1 wherein step a) comprises the step of providing a plurality of cutlines in said members to facilitate folding into non-planar surfaces.

3. The method recited in claim 1 further comprising the step of providing an access hole in at least one of said surfaces for adding candy to said piñata.

4. The method recited in claim 1 further comprising the step of applying decorative surfaces to said piñata after said gluing step.

5. The method recited in claim 1 further comprising the step of securing a rope to at least one of said surfaces for hanging said piñata.

6. A method of fabricating a star-shaped piñata; the method comprising the steps of:
a) pre-cutting separate planar cardboard members;
b) folding said members to provide individual non-planar surfaces in the form of a cylindrical drum having convex ends and a plurality of cones; and
c) gluing said surfaces together to form a star-shaped piñata wherein said cones extend symmetrically about said drum.

7. The method recited in claim 6 wherein step a) comprises the step of providing a plurality of cutlines in said members to facilitate folding into non-planar surfaces.

8. The method recited in claim 6 further comprising the step of providing an access hole in at least one of said surfaces for adding candy to said piñata.

9. The method recited in claim 6 further comprising the step of applying decorative surfaces to said piñata after said gluing step.

10. The method recited in claim 6 further comprising the step of securing a rope to at least one of said surfaces for hanging said pinata.
